(19) United States
(12) Patent Application Publication
(10) Pub. No.: US 2007/0249493 A1
(43) Pub. Date: Oct. 25, 2007

(54) Functionalized porous honeycomb structure, manufacturing method thereof and air cleaner using the same

(75) Inventors: Tomohisa Kawata, Nara-shi (JP); Jun Kudo, Nara-shi (JP); Hajime Tamon, Kyoto-shi (JP); Shin Mukai, Sapporo-shi (JP)

Correspondence Address: NIXON & VANDERHYE, PC, 901 NORTH GLEBE ROAD, 11TH FLOOR, ARLINGTON, VA, 22203, US

(73) Assignees: SHARP KABUSHIKI KAISHA, Osaka (JP); Hajime TAMON, Kyoto-shi (JP); Shin MUKAI, Sapporo-shi (JP)

(21) Appl. No.: 11/589,739

(22) Filed: Oct. 31, 2006

(30) Foreign Application Priority Data
Apr. 25, 2006 (JP) 2006-120859(P)
Apr. 25, 2006 (JP) 2006-120860(P)
Apr. 25, 2006 (JP) 2006-120861(P)

(51) Int. Cl. B01J 21/00; B01J 20/00

(52) U.S. Cl. 502/233; 502/400

(57) ABSTRACT

A novel porous honeycomb structure highly functionalized as compared with the conventional example, manufacturing method thereof and an air cleaner using the structure are provided. The functionalized porous honeycomb structure is a silica gel form, and fine powder for adding the function is dispersed in the form. Further the method of manufacturing in accordance with the present invention includes the steps of (a) preparing silica sol by mixing ion exchange resin in sodium silicate aqueous solution; (b) removing said ion exchange resin and adjusting pH; (c) dispersing fine powder for adding a function to the silica sol; (d) gelating the silica sol to provide silica wet gel; and (e) freezing the silica wet gel.

This nonprovisional application is based on Japanese Patent Applications Nos. 2006-120859, 2006-120860 and 2006-120861, all filed with the Japan Patent Office on Apr. 25, 2006, the entire contents of which are hereby incorporated by reference.

### BACKGROUND OF THE INVENTION

1. Field of the Invention

The present invention relates to a highly functionalized, porous honeycomb structure widely usable as an adsorbing and separating material or a catalyst support and to the manufacturing method thereof, as well as to an air cleaner using the same.

2. Description of the Background Art

A porous material is characterized in that it has numerous minute pores therein and has an extremely large inner surface area relative to an outer surface area. Therefore, it has been widely used as an adsorbent, a catalyst or catalyst support, a chromatography column, or a filter for an air conditioner or a water purifier. Such a porous material may be used in various shapes fit for the intended applications, including powder, particles, fiber, honeycomb, thin film and nanotube.

A filter for an air cleaner may be a representative example of fluid processing application. The most popular porous material used as a filter for an air cleaner is activated carbon. When the activated carbon in the shape of particles is used, the particles are filled in a container and the fluid is passed therethrough to be processed. Though this method is advantageous as it attains very large contact area between the fluid to be processed and the porous material, it has disadvantages that pressure loss is increased and high linear velocity cannot be attained.

A porous material formed in a honeycomb shape having straight flow path has been used, in order to reduce such pressure loss. Most of the honeycomb-shaped porous materials currently in use are fabricated by extrusion molding of ceramics. Generally, when the honeycomb-shaped porous material has higher cell density (number of cells per 1 square inch) and thinner honeycomb wall thickness, the contact area between the porous material and the fluid to be processed increases and, as a result, performance is improved. A technique of fabricating silica gel in the honeycomb shape, of which pore diameter can be adjusted to 5 to 50 μm and which has large specific surface area of 800 to 900 m² μg, is disclosed, by way of example, in Japanese Patent Laying-Open No. 2004-307294.

The porous honeycomb structure obtained by this method allows separating operation and adsorption utilizing minute pores thereof. The honeycomb structure, however, is not modified by a functional substance, and therefore, its properties have not fully been exhibited.

### SUMMARY OF THE INVENTION

The present invention was made to solve such problems and its object is to provide a novel porous honeycomb structure highly functionalized as compared with the prior art, as well as to provide a method of manufacturing such a structure. Another object of the present invention is to provide an air cleaner using the honeycomb structure.

According to an aspect, the present invention provides a functionalized porous honeycomb structure, wherein the structure is a form of silica gel, and fine powder for adding a function is dispersed in the form.

Here, preferably, the fine powder is electrically conductive fine powder, fine powder having adsorbing and catalytic functions, or fine powder having a photocatalytic function. As the electrically conductive fine powder, carbon nanofiber is preferably used. As the fine powder having adsorbing and catalytic functions, zeolite is preferably used. As the fine powder having photocatalytic function, TiO₂ is preferably used.

Preferably, the honeycomb structure in accordance with the present invention has average pore diameter of 5 to 200 μm and specific surface area of 700 to 1500 m²/g.

The honeycomb structure of the present invention may be obtained by formation through unidirectional freeze gelation, which will be described later.

According to another aspect, the present invention provides a method of manufacturing a functionalized porous honeycomb structure, including the steps of:

(a) preparing silica sol by mixing ion exchange resin in sodium silicate aqueous solution;

(b) removing the ion exchange resin and adjusting pH;

(c) dispersing fine powder for adding a function to the silica sol;

(d) gelating the silica sol to provide silica wet gel; and

(e) freezing the silica wet gel.

Preferably, dispersion of fine powder for adding the function described above to silica sol is attained by ultrasonic wave.

According to a still another aspect, the present invention provides an air cleaner using, as a filter, the honeycomb structure of the present invention described above.

According to the present invention, the porous honeycomb structure has the adsorbing function realized by silica and additionally has the function attained by the dispersed fine powder. Therefore, a honeycomb structure having higher functionality than the prior art can be provided.

By way of example, when electrically conductive fine powder is used as the fine powder for adding a function, not only the adsorbing function of silica but also electric conductivity realized by the dispersed fine powder can be exhibited, and therefore, utilizing such electric characteristic, a sensor for detecting a chemical substance having conventionally unattainable high sensitivity, or an air cleaner utilizing the same, can be provided.

When fine powder having adsorbing function and catalytic function is used as the fine powder for adding a function, not only the adsorbing function of silica but also the adsorbing function and catalytic function realized by the dispersed fine powder can be exhibited, and therefore, catalytic reaction for detoxifying harmful chemicals can effectively be effected in the entire honeycomb structure. Such a highly functionalized honeycomb structure of the present invention may suitably used, for example, as a filter of an air cleaner.

Further, when fine powder having photocatalytic function is used as the fine powder for adding a function, not only the adsorbing function of silica but also the photocatalytic function realized by the dispersed fine powder can be exhibited, and therefore, photocatalytic reaction for detoxifying harmful chemicals can effectively be effected in the entire honeycomb structure. Such a highly functionalized honeycomb structure of the present invention may suitably used, for example, as a filter of an air cleaner.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIGS. 1A and 1B are scanning electron microscope (SEM) photographs representing, partially in enlargement, a preferable example of the honeycomb structure in accordance with the present invention, in which FIG. 1A is a photograph of 200-fold magnification and FIG. 1B is a photograph of 400-fold magnification.

FIGS. 2A and 2B are SEM photographs representing, partially in enlargement, another preferable example of the honeycomb structure in accordance with the present invention, in which FIG. 2A is a photograph of 1000-fold magnification and FIG. 2B is a photograph of 6000-fold magnification.

FIGS. 3A and 3B are SEM photographs representing, partially in enlargement, a still further preferable example of the honeycomb structure in accordance with the present invention, in which FIG. 3A is a photograph of 400-fold magnification and FIG. 3B is a photograph of 6000-fold magnification.

FIG. 4 is a flowchart representing, in a simple manner, a preferable example of the method of manufacturing the honeycomb structure in accordance with the present invention.

FIGS. 5 to 7 are graphs representing XRD patterns of the honeycomb structures obtained in accordance with Examples 1, 3 and 4, respectively.

### DESCRIPTION OF THE PREFERRED EMBODIMENTS

(Honeycomb Structure)

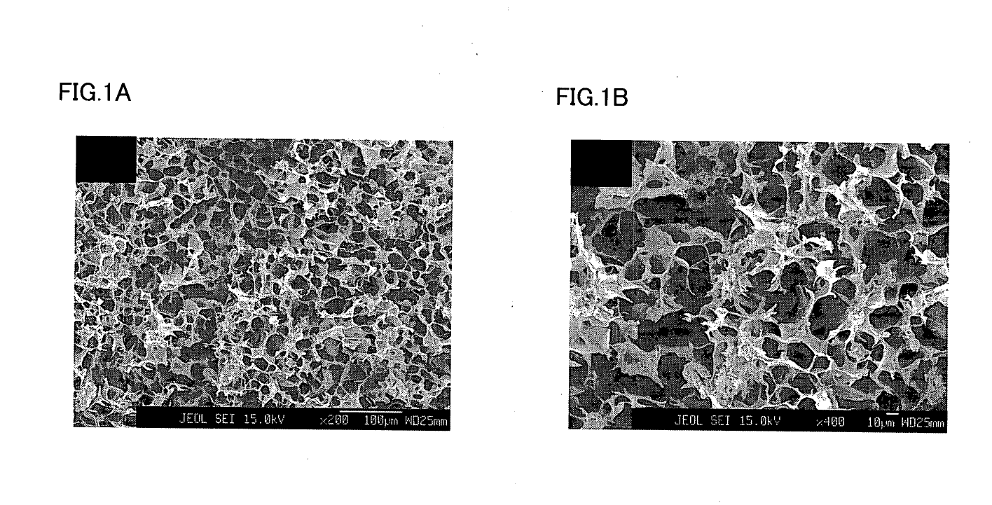

As shown in FIGS. 1A and 1B to 3A and 3B, the “porous honeycomb structure” in accordance with the present invention refers to a structure formed in a so-called “honeycomb”, having numerous pores of substantially uniform size when viewed from an arbitrary plane and further having numerous smaller fine pores formed in the pores, realizing a porous structure as a whole. In the present invention, such a porous honeycomb structure is realized by a silica form.

Though the shape of the porous honeycomb structure of the present invention is not specifically limited, by way of example, the structure is cut into a columnar body having a circular (a perfect circle or elliptical) or angular (triangular, rectangular or polygonal) cross-sectional shape. Here, it is preferred that the columnar body is cut such that the pores pass through opposite surfaces along the longitudinal direction of the columnar body. Though the size of such a columnar body is not specifically limited, preferably, the length along the longitudinal direction is in the range of 0.5 to 30 cm, and the area of the surface with respect to the longitudinal direction is in the range of 0.5 to 20 cm².

The honeycomb structure of the present invention is the porous honeycomb structure implemented by a silica form, having fine powder dispersed to add a function to the silica form. Therefore, a highly functionalized porous honeycomb structure having both the adsorbing function performed by the silica form and the new function performed by the dispersed fine powder can be realized.

As the fine powder for adding a function to the silica form, by way of example, electrically conductive fine powder, fine powder having adsorbing and catalytic functions, fine powder having photocatalytic function and the like may be used.

In the present specification, “electrically conductive” means that a current flows when a substance is placed in an electric field. Specifically, it means that resistivity is not higher than 1×10⁻⁴ Ωm. Whether a substance is electrically conductive or not may be confirmed, for example, by 4-terminal measurement of resistivity.

In the present specification, “adsorbing function” refers to adsorption of substance smaller than the diameter of regular fine pores derived from the crystal structure, in the regular fine pores. In the present specification, “catalytic function” refers to a function of promoting a chemical reaction, while the substance having the catalytic function itself is not altered. It is noted, however, that in the present specification, “catalytic function” does not include said function caused by light from the outside, that is, the photocatalytic function. By way of example, when the dispersed fine powder is zeolite, the “catalytic function” refers to the catalytic function utilizing the acidic property of zeolite.

Further, in the present specification, “photocatalytic function” refers to the following function. When a photocatalyst is irradiated by light beam of a certain wavelength, for example, ultraviolet ray, oxygen or water adsorbed on its surface is activated to be radicals with strong oxidizing power, and the radicals exhibit a function of oxidizing or decomposing organic or inorganic compound existing therearound.

Whether there is a photocatalytic function or not can be confirmed, by way of example, by putting methylene blue solution and a photocatalyst sample in one same container, inducing photocatalytic reaction by irradiating the sample with an UV lamp with the intensity of 1 mW/cm² at the sample surface, and measuring variation in absorbance using a spectrophotometer.

In the honeycomb structure of the present invention, that the fine powder for adding a function is “dispersed” means that the fine powder is almost uniformly distributed in the silica form. That the fine powder for adding a function is dispersed in the honeycomb structure can be confirmed by using, for example, an electron microscope.

As the electrically conductive fine powder of the present invention, conventionally known powder may appropriately be used, and it is not specifically limited. By way of example, carbon nanofiber, carbon nanotube, and carbon black, may be used. Among these, it is preferred to use one selected from carbon nanofiber and carbon nanotube, having narrow particle size distribution and the size in the order of nano meter. In view of cost, use of carbon nanofiber is particularly preferred. As the electrically conductive fine powder for the honeycomb structure of the present invention, commercially available powder may preferably be used and, by way of example, fine powder carbon nanofiber (diameter of 40 to 50 nm, aspect ratio of at least 1000) may be used.

The content of electrically conductive fine powder dispersed in the honeycomb structure of the present invention is not specifically limited, as long as the conductivity as described above can be attained by the honeycomb structure as a whole, and it depends on the type of the conductive fine powder to be used. When carbon nanofiber is used as the electrically conductive fine powder, for example, it is preferred that the content is 6 to 20 parts by weight with respect to 100 parts by weight of SiO₂ contained in silica sol. When the content is smaller than 6 parts by weight, the honeycomb structure as a whole would not exhibit sufficient electric conductivity. When the content exceeds 20 parts by weight, formation of honeycomb structure would possibly fail.

Though the particle diameter of the electrically conductive fine powder used in the present invention is not specifically limited, preferable range is 10 to 100 nm, and more preferable range is 30 to 80 nm. The particle diameter of the electrically conductive fine powder contained in the honeycomb structure may be measured by direct observation by a scanning electron microscope.

As the fine powder having the adsorbing and catalytic functions used in the present invention, conventionally known powder may appropriately be used, and it is not specifically limited. By way of example, zeolite and phosphate-based zeolite-like material may be used. Of these, use of zeolite is preferred, as it is relatively readily available and inexpensive. As the fine powder having the adsorbing and catalytic functions used for the honeycomb structure of the present invention, commercially available powder may preferably be used. For example, as zeolite, A-type zeolite (Tosoh Corporation, zeolum A-4) having high adsorbing performance, or high-silica zeolite (Tosoh Corporation, USY zeolite (HSZ-390 HUA)) having high catalytic function may be used.

The content of the fine powder having the adsorbing and catalytic functions dispersed in the honeycomb structure of the present invention is not specifically limited as long as the adsorbing and catalytic functions of the dispersed fine powder are successfully attained, and it depends on the type of fine powder to be dispersed. When zeolite is used as the fine powder having the adsorbing and catalytic functions, for example, preferable content is 6 to 120 parts by weight with respect to 100 parts by weight of SiO₂ contained in silica sol, and more preferable range is 20 to 100 parts by weight. When the content is smaller than 6 parts by weight, the honeycomb structure would not exhibit sufficient adsorbing and catalytic functions. When the content exceeds 120 parts by weight, formation of honeycomb structure would possibly fail.

Though the particle diameter of the fine powder having the adsorbing and catalytic functions used in the present invention is not specifically limited, preferable range is 0.2 to 2 μm, and more preferable range is 0.4 to 0.8 μm.

As the fine powder having the photocatalytic function used in the present invention, conventionally known powder may appropriately used, and it is not specifically limited. By way of example, TiO₂, ZnO, SrTiO₃, CdS, ZnS, CuS, Ru complex, porphyrin complex of Zn and Al, metal phthalocyanine and the like may be used. Among these, it is preferred to use one selected from TiO₂, ZnO and SrTiO₃, which are readily available and most vigorously studied metal oxide semiconductor photocatalyts. Use of TiO₂ is particularly preferable. As the fine powder having the photocatalytic function used for the honeycomb structure of the present invention, commercially available fine powder may preferably be used and, by way of example, TiO₂ crystalline fine powder P-25 (Nihon Aerosil) may be used.

The content of the fine powder having the photocatalytic function dispersed in the honeycomb structure of the present invention is not specifically limited, as long as the photocatalytic function as described above can be attained by the honeycomb structure as a whole, and it depends on the type of the fine powder having the photocatalytic function to be used. When TiO₂ is used as the fine powder having the photocatalytic function, for example, preferable content is 6 to 80 parts by weight with respect to 100 parts by weight of SiO₂ contained in silica sol, and more preferable content is 20 to 60 parts by weight. When the content is smaller than 6 parts by weight, the honeycomb structure would not exhibit sufficient photocatalytic function. When the content exceeds 80 parts by weight, formation of honeycomb structure would possibly fail.

Though the particle diameter of the fine powder having the photocatalytic function used in the present invention is not specifically limited, preferable range is 1 to 30 nm. When the particle diameter of fine powder having the photocatalytic function exceeds 30 nm, the photocatalytic function tends to degrade.

Though the average pore diameter of the honeycomb structure of the present invention is not specifically limited, preferable range is 5 to 200 μm, because pressure loss increases as the average pore diameter becomes smaller, when the honeycomb structure of the present invention is used, for example, as a filter. The average pore diameter of the honeycomb structure represents the value measured by direct observation of a cross-section of the honeycomb structure by a scanning electron microscope (SEM) and by analyzing the SEM photograph, as shown in FIGS. 1A, 1B to 3A and 3B.

The specific surface area of the honeycomb structure in accordance with the present invention is not specifically limited, and preferable range is 700 to 1500 m²/g. The specific surface area of the honeycomb structure represents the value obtained by nitrogen adsorption/desorption measurement at −196° C., for example, and by analyzing the resulting adsorption/desorption isotherm using BET plot.

Conventionally, a filling type reactor has surface area to volume ratio of 1×10⁶ to 5×10⁸ m²/m³, and hence has extremely high activity. Generally, when the average pore diameter of a honeycomb structure becomes smaller, the specific surface area tends to increase and the wall thickness of the honeycomb structure tends to decrease. Therefore, the surface area to volume ratio becomes smaller by 1 to 3 orders of magnitude than the filling type reactor, to 1×10³ to 5×10⁵ m²/m³. In the honeycomb structure of the present invention, however, the material is porous and, therefore, the specific surface area does not much change even when the average pore diameter is changed. Therefore, the surface area to volume ratio will be 7×10⁷ to 1×10⁸ m²/m³. It is particularly preferred that the honeycomb structure of the present invention is realized to have the average pore diameter in the range of 5 to 200 μm and the specific surface area of 700 to 1000 m²/g (7×10⁷ to 1×10⁸ m²/m³). Conditions for manufacturing the honeycomb structure having the average pore diameter and specific surface area of the preferable ranges will be described later.

In the honeycomb structure of the present invention, it is preferred that the fine pores formed in the pores has the size of 1 to 50 nm. In order to improve reactivity or adsorption capacity, it is necessary to increase surface area, and hence, it is preferred that a large number of micro pores having the diameter of 2 nm or smaller are provided. On the other hand, the rate of molecular diffusion is very slow in the micro pores, and hence, in order to attain efficient molecular diffusion, presence of meso pores having the diameter of 2 to 50 nm is also important. The pore size and the pore size distribution may be calculated by nitrogen adsorption/desorption measurement at −196° C., for example, and by analyzing the resulting adsorption/desorption isotherm using Dollimore-Heal method.

(Method of Manufacturing Honeycomb Structure)

Though the method of manufacturing the honeycomb structure of the present invention described above is not specifically limited, it is preferred that the structure is formed by utilizing unidirectional freeze gelation. It is more preferred that the structure is formed by the manufacturing method of the present invention, which will be described later. Here, the freeze gelation refers to a method of gelation utilizing the freeze concentration effect. When sol is frozen, phase separation occurs, resulting in two phases, that is, a phase in which almost pure water is frozen, and a phase in which colloid particles are concentrated. The effect of promoting gelation by concentration is so high, that even at a low temperature, colloid particles collected in the gap in the ice are bonded and turned to gel. Here, the ice serves as a template, and after thawing and drying, the sample having the shape as frozen can be obtained. As a method of controlling growth of ice, unidirectional freezing has been known. In this method, gel of metal oxide is frozen with directivity, so that ice is grown as pillars in one direction to provide a plurality of ice pillars, and particles are collected in the spaces among the pillars. The conventional unidirectional freezing has been known as a method of fabricating polygonal fiber of metal oxide gel, and has been mainly applied to hard, wet gel of a structure obtained by aging for a long time. In the manufacturing method of the present invention, the freeze gelation method and the unidirectional freezing method are combined and the application of the unidirectional freezing method is widened to sol and wet gel immediately after gelation, to manufacture the porous honeycomb structure.

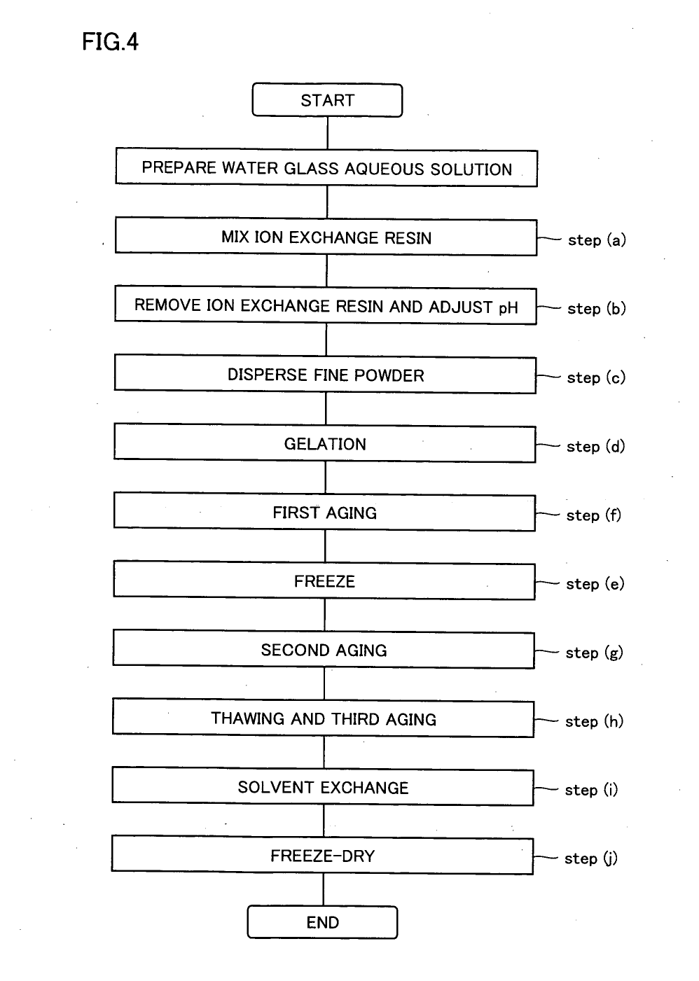

FIG. 4 is a flowchart schematically representing a preferred example of the method of manufacturing the honeycomb structure in accordance with the present invention. The method of manufacturing the honeycomb structure of the present invention is characterized in that it includes the following steps (a) to (e):

(a) preparing silica sol by mixing ion exchange resin in sodium silicate aqueous solution;

(b) removing the ion exchange resin and adjusting pH;

(c) dispersing fine powder for adding a function to the silica sol;

(d) gelating the silica sol to provide silica wet gel; and

(e) freezing the silica wet gel.

In the following, the manufacturing method of the present invention will be described with reference to FIG. 4. According to the manufacturing method of the present invention, first, using sodium silicate solution (water glass) as a raw material, sodium silicate aqueous solution is prepared by diluting with pure water. When the concentration of the sodium silicate aqueous solution is too low, solute for forming the honeycomb wall is insufficient, and when the concentration is too high, gelation starts during ion exchange. Therefore, the concentration should preferably be adjusted to the range of 1.0 to 2.0 M.

Next, to the sodium silicate aqueous solution prepared in this manner, ion exchange resin is added and mixed, to prepare silica sol (step (a)). Step (a) is performed to adjust pH of silica sol using the water glass as a raw material, and to sufficiently remove Na ions as impurity that alters characteristics when adsorbed to the surface of silica particles, so that porous honeycomb structure having regular average pore diameter is formed. Specifically, to the sodium silicate aqueous solution contained in a vessel with a pH meter (and an ion meter, as needed), ion exchange resin is added until desired pH value (for example, pH2 to 3) is reached.

Though the ion exchange resin used in step (a) is not specifically limited, use of highly acidic ion exchange resin is preferred, because Na ions in the silica sol can sufficiently be removed while pH is adjusted. An example of such ion exchange resin is Amberlite IR120B H AG of Organo Corporation.

The amount of ion exchange resin to be mixed with the sodium silicate aqueous solution is not specifically limited, either. It is preferred, however, that the volume is one half to approximately the same as the volume of the aqueous solution. Though it depends on the concentration of sodium silicate aqueous solution to be prepared, when the amount of ion exchange resin is smaller than that described above, removal of Na ions would possibly be insufficient. When the amount of ion exchange resin is larger than that described above, pH would be too small and gelation takes long time.

In the next step, the ion exchange resin mixed in step (a) is removed (step (b)). The ion exchange resin may be removed by using, for example, a suitable sieve. When specific surface area is to be controlled here, aqueous solution of ammonia is added after removal of ion exchange, for pH adjustment.

In the next step, fine powder for adding a function is dispersed in silica sol (step (c)). Suitable types and amounts of the fine powder are as described above. In the present invention, dispersion of the fine powder for adding a function may be effected by stirring or using ultrasonic wave, and use of ultrasonic wave is preferred. When the fine powder is dispersed by stirring, it is possible that distribution of the powder becomes uneven or the powder is not dispersed but precipitates. Dispersion using ultrasonic wave enables uniform distribution of the fine powder in the entire sol. In this manner, composite slurry having the fine powder for adding a function uniformly dispersed in silica sol can be provided. For the dispersion using ultrasonic wave, by way of example, an ultrasonic dispersing apparatus (VC750, manufactured by SONICS & MATERIAL) may be used.

In the next step, silica sol is gelated to obtain silica wet gel (step (d)). Gelation of silica sol may be performed by filling the composite slurry obtained in the step described above in a tubular vessel (cell) to be used in the next step (e), and leaving it stationary for about 2 to 8 hours at a temperature range of 20 to 40° C. Thus, silica wet gel having fine powder for adding a function dispersed can be provided. It is naturally possible to perform gelation of silica sol in a different vessel and to put the resulting silica wet gel in the tubular vessel to be used in step (e).

Next, the silica wet gel obtained in step (d) is frozen (step (e)). Freezing of the silica wet gel is performed by inserting the gel in the tubular vessel (cell) to a coolant such as liquid nitrogen from one direction at a prescribed rate of insertion using, for example, a constant speed motor. As the silica wet gel is inserted to the coolant from one direction, the ice grows at the portion put in the coolant, as a pillar along the direction of insertion.

In order to obtain the porous honeycomb structure of the present invention after freezing, the time of aging to the start of freezing of the silica wet gel (first aging, step (f)) is controlled. The time of aging is preferably in the range of 0.5 to 12 hours. As the aging time becomes longer, the shape after freezing changes from thin film, flat fiber, honeycomb to polygonal fiber (see Japanese Patent Laying-Open No. 2004-307294 described above). Such a change in shape is considered to come from mobility of silica particles at the time of freezing. As the time of aging becomes longer, gelation proceeds and motion of silica particles is inhibited. When the aging time is short, silica particles are relatively movable, and hence, the particles collect to form continuous thin film or flat fiber. About the time of gelation, silica particles hardly move, and therefore, the particles existing around the ice pillars are frozen as they are, forming the honeycomb shape. When gelation further proceeds, the particles are separated by the growth of ice pillars, resulting in fiber shape. Therefore, by adjusting the time of first aging, it is possible to form the silica gel of honeycomb shape.

Further, by changing the conditions of freezing at step (e), the diameter of ice pillars serving as the template can be changed, and therefore, it is possible to form the porous honeycomb structure having the desired average pore diameter. Preferable freezing conditions are −196° C. to −10° C. and insertion rate of 0.5 to 70 cm/h, and more preferable conditions are −196° C. to −20° C. and 1 to 20 cm/h. As described above, unidirectional freeze gelation is a sort of wet synthesis method, and therefore, it can be used in combination with the superior nano structure control technique of sol-gel method. Therefore, when the porous material is fabricated using this method, the nano pore characteristics (average fine pore diameter, specific surface area, pore volume) of the finally obtained honeycomb structure can precisely be controlled by adjusting raw material composition and aging conditions.

In the method of manufacturing the honeycomb structure of the present invention, it is preferred to perform, after freezing at step (e) above, aging for a prescribed time period (second aging) in the frozen state (step (g)). By performing the second aging, it becomes possible to reinforce the gel structure while the ice is serving as the template. Preferably, the second aging is performed at a relatively low temperature of −196° C. to −20° C. for 1 to 3 hours.

Next, thawing step follows (step (h)). Thawing is done by putting the tubular vessel (cell) after second aging into a constant-temperature bath of, for example, 50° C. When aqueous solution of ammonia has not been added at step (b), an aging (third aging) in which the formed silica wet gel is immersed in an aqueous solution of ammonia for a prescribed time period may be performed after thawing, to control pore characteristics. It is preferred that the third aging is performed at a temperature of 30 to 80° C. for 1 to 3 hours.

After thawing or third aging (step (h)), solvent exchange is performed (step (i)). Though the solvent used for the solvent exchange is not specifically limited, by way of example, t-butanol is used. The reason why t-butanol is used is as follows: (1) density change between liquid-solid phase transition is small (Δp=−3.4×10⁻⁴ g/cm³ at 299K), so that possibility of damaging the sample at the time of solidification is small, and (2) vapor pressure is high (vapor pressure of t-butanol at 0° C. is p₀=821 Pa, while that of water is 61 Pa), and drying rate is high. Specifically, the honeycomb structure is taken out from the tubular vessel (cell) and immersed in t-butanol of at least 5 times larger in volume, the third aging is stopped and, in this state, t-butanol is exchanged at least three times in two to four days. Through cleaning with t-butanol, small amount of water contained in the honeycomb structure is replaced by t-butanol.

In the method of manufacturing the honeycomb structure of the present invention, it is preferred to perform drying (step (j)), after the solvent exchange (step (i)). Though the method of drying is not specifically limited and a conventionally known method may appropriately be used, freeze-drying is preferred as cracks of silica and damage to pores are not likely during drying. For freeze-drying, preferable temperature range is −10° C. to −30° C., because when the temperature is high, the solvent would not be fully frozen and when the temperature is too low, the rate of drying becomes slow.

(Air Cleaner)

The honeycomb structure in accordance with the present invention described above may suitably be used as a filter for an air cleaner. The present invention also provides an air cleaner using the honeycomb structure of the present invention as a filter. For the air cleaner of the present invention, a conventionally known general structure may be used, except that the honeycomb structure of the present invention as described above is used as the filter. By way of example, in a housing of an appropriate shape having an air inlet and an air outlet, the air passes through the air inlet, a dust collector filter and a blower (such as a propeller-shaped fan, or an air compressing apparatus using a pressure nozzle), and then fed to the filter and the filtered air is discharged through the air outlet to the outside of the air cleaner. As the filter, the porous honeycomb structure described above cut into the shape of a pillar may be used, and preferably, it is arranged such that the direction of pores formed in the honeycomb structure and the direction of air passage are approximately parallel to each other (that is, the longitudinal direction of the pillar is approximately parallel to the direction of air passage).

By such an air cleaner, because of the filter implemented by the porous honeycomb structure having not only the adsorbing function but also electrically conductive function, catalytic function or photocatalytic function, it becomes possible to effectively remove harmful substances (such as formaldehyde, benzene, toluene, xylene, or nitrogen oxide) in the air.

In the following, the present invention will be described in detail with reference to specific examples, though the present invention is not limited to these examples.

### EXAMPLES

### Example 1

By diluting 54% sodium silicate solution with deionized distilled water, 25 mL of sodium silicate aqueous solution having the SiO₂ concentration of 1.9 mol/L was obtained. While the solution was stirred, 29 mL of H⁺ type highly acidic ion exchange resin was added so that pH of the aqueous solution was adjusted around 2.5, and silica sol was obtained. Ion exchange resin was removed, and thereafter, 20 parts by weight of carbon nanofiber having the particle diameter of 40 to 50 nm (aspect ratio: at least 1000) was added to 100 parts by weight of SiO₂ contained in silica sol, and dispersed in silica sol using an ultrasonic dispersion machine. The resulting body was poured into a tube formed of polypropylene having an inner diameter of 1.3 cm, the tube was closed by a lid, and left stationary at 30° C. The sample became uniform gel after 4 hours. After gelation, the first aging was conducted at 30° C. for 1 hour, and then, the tube was inserted to a coolant bath controlled such that the surface level of liquid nitrogen in the container was kept constant, under the freezing conditions of −196° C. and insertion rate of constant speed motor being 8 cm/h. After the sample was fully frozen, the sample was put in a constant temperature bath of 50° C. and thawed. After thawing, the sample was taken out from the tube, and the sample was immersed in t-butanol. Thereafter, cleaning with t-butanol was performed at least three times over three days, and the water contained in the sample was fully replaced by t-butanol. The sample after full solvent exchange was freeze-dried at −10° C., and the electrically conductive porous honeycomb structure of the present invention was obtained.

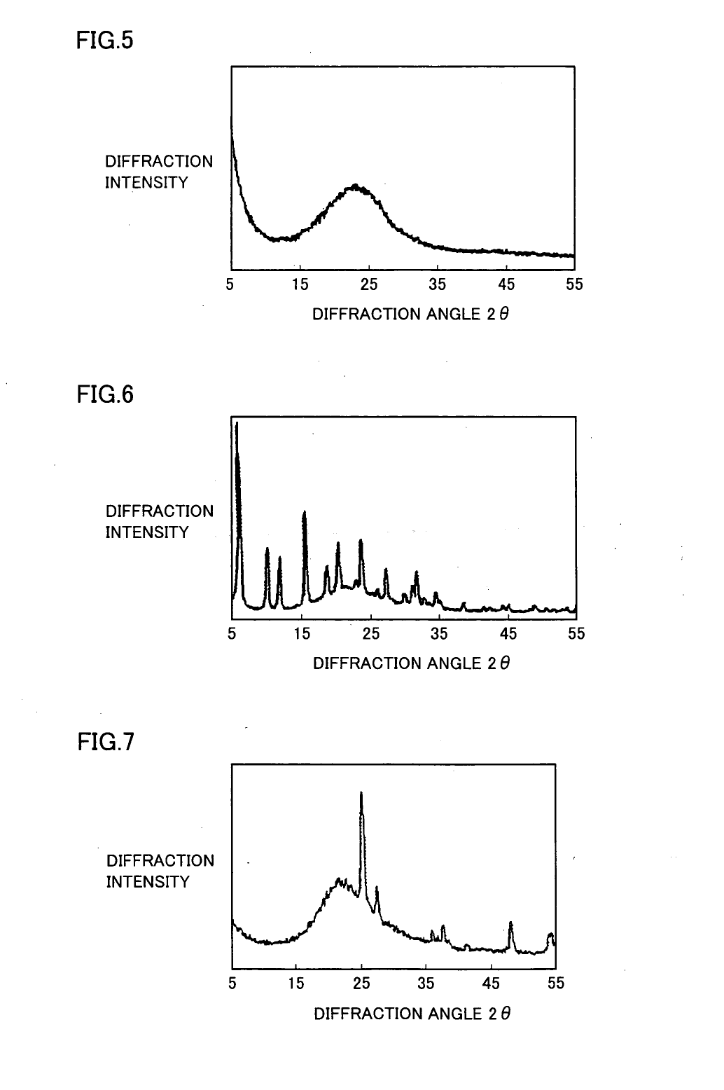

FIGS. 1A and 1B are scanning electron micrographs (SEM) of the honeycomb structure obtained in accordance with Example 1, and FIG. 5 shows an X-ray Diffraction (XRD) pattern. From the electron micrographs, it was confirmed that in the honeycomb structure of Example 1, carbon nanofiber as electrically conductive powder was uniformly dispersed in the silica gel. Further, average pore diameter of the honeycomb structure in accordance with Example 1 was 16 μm (from the analysis of SEM photograph, same in the following), and the specific surface area was 783 m² μg (by nitrogen adsorption/desorption measurement at −196° C. and analyzing the resulting adsorption/desorption isotherm using BET plot). Further, the average fine pore diameter of the honeycomb structure in accordance with Example 1 was 3.02 nm (calculated by nitrogen adsorption/desorption measurement at −196° C., calculating the amount of nitrogen adsorption from the resulting adsorption/desorption isotherm, and dividing the thus obtained value by BET surface area; same in the following). Further, the XRD pattern of the honeycomb structure in accordance with Example 1 matched the XRD pattern of carbon nanofiber measured by itself, and thus, it was confirmed that the honeycomb structure was electrically conductive.

### Example 2

An electrically conductive porous honeycomb structure was obtained in the similar manner as Example 1, except that 6 parts by weight of carbon nanofiber having the particle diameter of 40 to 50 nm (aspect ratio: at least 1000) were added to 100 parts by weight of SiO₂ contained in the silica sol.

The scanning electron micrographs (SEM) and the XRD pattern of the honeycomb structure obtained in accordance with Example 2 were similar to those of the honeycomb structure in accordance with Example 1. The average pore diameter of honeycomb structure in accordance with Example 2 was 15 μm, and the specific surface area was 998 m²/g. The average fine pore diameter was 2.88 nm.

### Example 3

A porous honeycomb structure having the adsorbing and catalytic functions in accordance with the present invention was obtained in the similar manner as Example 1, except that in place of carbon nanofiber, 60 parts by weight of high silica zeolite (Tosoh Corporation, USY zeolite (HSZ-390 HUA), SiO₂/Al₂O₃ (mol/mol)=400) having the particle diameter of 600 nm was added to 100 parts by weight of SiO₂ contained in the silica sol. The silica sol having high silica zeolite dispersed therein was poured into a tube of polypropylene, the tube was closed with a lid and left stationary at 30° C. It took 3 hours until the sample became uniform gel.

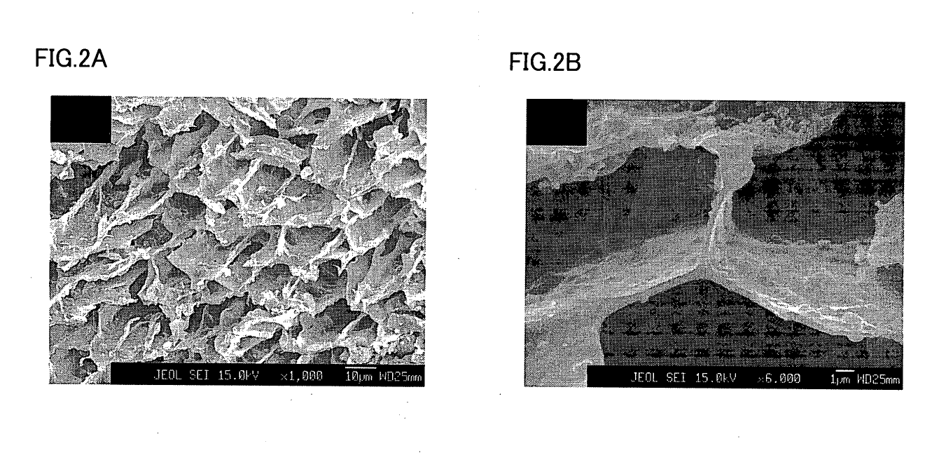

FIGS. 2A and 2B are scanning electron micrographs (SEM) of the honeycomb structure obtained in accordance with Example 3, and FIG. 6 shows an X-ray Diffraction (XRD) pattern. From the electron micrographs, it was confirmed that in the honeycomb structure of Example 3, high silica zeolite as fine powder having the adsorbing and catalytic functions was dispersed uniformly in the silica gel. The average pore diameter of the honeycomb structure in accordance with Example 3 was 13 μm, and the specific surface area was 951 m²/g. Further, average fine pore diameter of the honeycomb structure in accordance with Example 3 was 2.74 nm. The XRD pattern of the honeycomb structure in accordance with Example 3 matched the XRD pattern of high silica zeolite measured by itself, and thus, it was confirmed that the honeycomb structure had the adsorbing and catalytic functions.

### Example 4

A porous honeycomb structure having the photocatalytic function in accordance with the present invention was obtained in the similar manner as Example 1, except that in place of carbon nanofiber, 60 parts by weight of TiO₂ crystalline fine powder (P-25, manufactured by Nihon Aerosil) was added to 100 parts by weight of SiO₂ contained in the silica sol and that after the sample was fully frozen, the second aging was performed at the same temperature for 2 hours. The silica sol having TiO₂ crystalline fine powder dispersed therein was poured into a tube of polypropylene, the tube was closed with a lid and left stationary at 30° C. It took 4 hours until the sample became uniform gel.

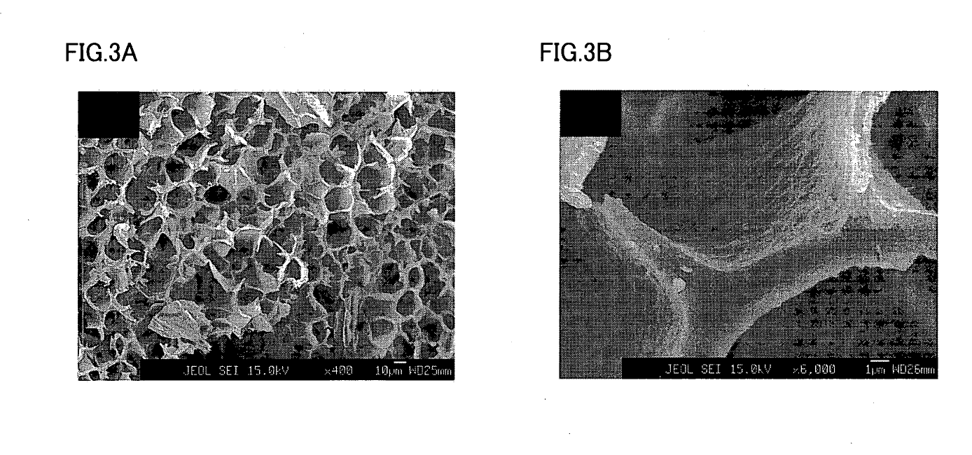

FIGS. 3A and 3B are scanning electron micrographs (SEM) of the honeycomb structure obtained in accordance with Example 4, and FIG. 7 shows an X-ray Diffraction (XRD) pattern. From the electron micrographs, it was confirmed that in the honeycomb structure of Example 4, TiO₂ crystalline fine powder as the fine powder having photocatalytic function was dispersed uniformly in the silica gel. The average pore diameter of the honeycomb structure in accordance with Example 4 was 14 μm, and the specific surface area was 795 m²/g. Further, average fine pore diameter of the honeycomb structure in accordance with Example 4 was 2.88 nm. The XRD pattern of the honeycomb structure in accordance with Example 4 matched the XRD pattern of the photocatalyst measured by itself, and thus, it was confirmed that the honeycomb structure had the photocatalytic function.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A functionalized porous honeycomb structure, wherein
said structure is a form of silica gel; and
fine powder for adding a function is dispersed in said form.

2. The honeycomb structure according to claim 1, wherein
said fine powder is electrically conductive fine powder.

3. The honeycomb structure according to claim 2, wherein
said fine powder is carbon nanofiber.

4. The honeycomb structure according to claim 1, wherein
said find powder is fine powder having adsorbing and catalytic functions.

5. The honeycomb structure according to claim 4, wherein
said fine powder is zeolite.

6. The honeycomb structure according to claim 1, wherein
said fine powder is fine powder having photocatalytic function.

7. The honeycomb structure according to claim 1, having average pore diameter of 5 to 200 μm and specific surface area of 700 to 1500 m²/g.

8. The honeycomb structure according to claim 1, formed by unidirectional freeze gelation.

9. A method of manufacturing a functionalized porous honeycomb structure, comprising the steps of:
(a) preparing silica sol by mixing ion exchange resin in sodium silicate aqueous solution;
(b) removing said ion exchange resin and adjusting pH;
(c) dispersing fine powder for adding a function to the silica sol;
(d) gelating the silica sol to provide silica wet gel; and
(e) freezing said silica wet gel.

10. The method of manufacturing the honeycomb structure according to claim 9, wherein
said fine powder is dispersed in the silica sol by ultrasonic wave.

11. An air cleaner using the honeycomb structure according to claim 1 as a filter.
